(19) United States
(12) Patent Application Publication
(10) Pub. No.: US 2004/0023019 A1
(43) Pub. Date: Feb. 5, 2004

(54) Particulate transfer film with improved bead carrier

(75) Inventors: John L. Vandenberg, Maplewood, MN (US); Shane M. Klundt, Hudson, WI (US); Michael D. Currens, Eagan, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/210,924

(22) Filed: Aug. 2, 2002

(51) Int. Cl. B32B 3/00

(52) U.S. Cl. 428/323; 428/343

(57) ABSTRACT

A transfer film configured for transferring optical beads to a substrate is disclosed. The transfer film typically contains optical beads, a temporary bead carrier layer retaining the optical beads, and an optional adhesive layer configured to permanently adhere the optical beads to a substrate. The temporary bead carrier layer contains a carrier backing and a heat-resistant carrier coating that temporarily holds the beads during application at elevated temperatures to a substrate. The carrier coating is formed such that it initially softens to retain the beads, but is then hardened or thermoset (such as by crosslinking) to prevent the carrier coating from softening during transfer of the beads to a substrate.

### FIELD OF THE INVENTION

The present invention is directed to transfer films used to transfer particulates to substrates. More particularly, the invention is directed to transfer films used to transfer a layer of transparent beads or other particulates to a substrate, such as a fabric, and to methods of making and using the transfer films. The invention has particular utility in retroreflective transfer films in which the layer of transparent beads is patterned.

### BACKGROUND

Retroreflective sheetings are commonly used to increase nighttime conspicuity of objects as diverse as street signs, pavement markings, vehicles, and clothing. Many retroreflective sheetings use glass beads as retroreflective elements in the sheetings. The beads are transferred to the final object using a thermal press that adheres the beads with a heat-activated adhesive. The adhesive and beads can be delivered in a multi-layer film that contains the beads, an adhesive layer, an optional release liner covering the adhesive, and a temporary bead carrier that holds the beads prior to placement on the substrate. In some implementations other layers are also used, such as a bead-bond layer configured to bind the beads together and to the adhesive, plus an aluminum reflector layer on the bottoms of the beads to improve their reflectivity.

U.S. Pat. No. 3,172,942 (Berg) discloses one method of manufacturing such sheetings. The method begins with attachment of unreflectorized glass beads to a temporary bead carrier. The temporary bead carrier can be either paper or polymeric sheeting having a coating of a thermoplastic polymer, often polyethylene, capable of being softened by heat. Glass beads partially sink into the softened polymer upon heating. The carrier is subsequently cooled and retains the beads until they are installed on the substrate. After subsequent processing steps the temporary bead carrier is stripped from the laminate to reveal the beads.

The beads on the sheeting and finished object may be applied in a pattern of an image or indicia, such as lettering or logos. Patterns are particularly common when beads are applied to clothing. One way of forming such patterns is to begin with retroreflective sheeting having a uniform layer of beads spread along a temporary bead carrier and covered with an adhesive layer. A plotter having a knife is used to kiss cut the pattern from the piece of sheeting. Laser cutting or die cutting may also be used. The kiss cutting is done such that a cut extends through the adhesive layer and beads, but not through the temporary bead carrier. Waste material, often called “weed”, is then removed, leaving only the desired pattern of beads and adhesive on the temporary carrier. The removed weed includes the beads and adhesive, plus other layers such as an adhesive release liner. The temporary bead carrier normally retains its original size and shape since it was uncut by the plotter, and retains the pattern of beads.

Attachment of the formed pattern to a substrate, such as clothing or fabric, can be accomplished by the following steps. First, the pattern is placed on the substrate in the desired position such that the heat activated adhesive faces the substrate and the temporary bead carrier faces outward. Second, a heated press is used to activate the adhesive and press the layers together. After cooling, the temporary bead carrier is removed, leaving a retroreflective indicia attached to the substrate.

Two problems can occur during the cutting and lamination process with these conventional sheetings. First, the action of cutting the layers with a plotter can cause premature separation of the transfer film from the temporary bead carrier, making handling very difficult during the subsequent application steps. Second, the thermoplastic coating material used in the temporary bead carrier can partially melt and transfer to the substrate during the lamination step, leaving the temporary bead carrier difficult or impossible to completely remove, and an unacceptable residue in areas surrounding the desired retroreflective pattern. Therefore, a need exists for improvements that will alleviate these problems.

### BRIEF SUMMARY

The present application discloses transfer films configured for transferring particulates to a substrate. In certain implementations the particulates include beads. In such implementations the transfer film contains at least the following materials or layers: beads and a temporary bead carrier retaining the beads. The temporary bead carrier typically contains a heat-resistant carrier coating material that temporarily holds the beads during application to a substrate. The carrier coating is formed such that it initially softens to temporarily retain the beads but is then hardened or thermoset (such as by crosslinking) to prevent the carrier coating from melting during transfer of the beads to a substrate. This carrier coating is adhered to a carrier backing, such as a paper or plastic film.

In most implementations the transfer film also includes a reflective coating applied to the beads, an adhesive to secure the beads to a substrate, and a bead-bond layer that secures the beads to one another and to the adhesive. Suitable reflective coatings include metal coatings, such as aluminum. Suitable bead-bond layers include, for example, phenolic resin and nitrile butadiene rubber (NBR).

In certain embodiments the carrier coating of the temporary carrier layer is formed from a thermoplastic material that is irradiated to make it thermoset. For example, the thermoset carrier coating can be formed by exposing a thermoplastic material to an electron beam source. As described above, the carrier coating is beneficially thermoplastic during manufacture to allow beads to be temporarily secured to it, but is thereafter altered to be thermoset so that any exposed carrier coating does not bind to the substrate during application of the beads to the substrate.

As used herein, the term “thermoset” refers to a composition that does not undergo significant softening when raised to an elevated temperature, in particular the application temperature at which the beads or other particulates are transferred to a substrate. Significant softening is regarded as being, for example, enough softening such that the composition will readily and materially transfer to the substrate during transfer of the beads to the substrate. Thus, materials that will readily and materially transfer to the substrate at normal application temperatures are not considered to be “thermoset”. Useful thermoset materials are typically formed from materials that are originally thermoplastic, meaning they can repeatedly be softened at elevated temperatures, but are altered to become thermoset by the crosslinking reactions described herein.

Also, it is desirable that the beads form a sufficiently strong bond to the carrier coating such that the process of forming a pattern does not inadvertently cause unintentional release of the bead layer from the temporary bead carrier. This problem can be particularly pronounced when using automatic plotter cutters, and therefore it is important in automated, high-production facilities.

The adhesive layer is used to permanently adhere the beads to a substrate, such as a fabric. The adhesive layer can be, for example, a thermoplastic adhesive composition. The adhesive composition can vary for different applications, but in general it should be selected such that it will readily adhere to the intended substrate and provide a durable bond for the beads (or bead-bond layer) to the substrate. Suitable adhesives include, for example, polyester type thermoplastic polyurethane.

Beads useful in the present constructions are generally optical glass beads, normally retroreflective optical beads. The beads may be of various sizes and shapes, but are commonly spherical and from about 60 to 120 microns in diameter. Non-optical beads or other particulate materials may also be used.

Further disclosed are methods of making a particulate transfer film. One such method includes providing a thermoplastic layer that is softened by heat, impregnated with a particulate material, such as optical beads, and then crosslinked to form a thermoset layer having an elevated softening or degradation temperature. Thus, the thermoplastic material becomes thermoset by being crosslinked.

The above summary is not intended to be limiting, nor is it intended to describe each illustrated embodiment or every implementation of the present disclosure. Rather, the invention for which exclusive rights are sought is defined by the full scope of the appended claims, as they may be amended.

### FIGURES

The invention will be more fully explained with reference to the following drawings, where like reference numerals refer to like elements, and where:

FIG. 1 is a partial cross-sectional view of a transfer film that includes an adhesive layer, a bead layer with a reflector coating, a bead-bond layer, a removable adhesive liner, and a temporary bead carrier;

FIG. 2 is a partial cross-sectional view of the transfer film of FIG. 1, depicting a portion of the adhesive layer, adhesive liner, bead-bond layer, reflector layer and bead layer removed;

FIG. 3 is a partial cross-sectional view of the transfer film of FIG. 2, depicting the film rotated 180 degrees and following removal of the removable adhesive liner;

FIG. 4 is a partial cross-sectional view of the transfer film of FIG. 3, depicting the film after heat transfer to a substrate;

FIG. 5 is a partial cross-sectional view of the transfer film of FIG. 4, depicting the film after heat transfer to a substrate and removal of the temporary bead carrier;

FIG. 6 is a partial cross-sectional view of a transfer film that includes an adhesive layer, a bead layer, a removable adhesive liner, and a temporary bead carrier;

FIG. 7 is a partial cross-sectional view of the transfer film of FIG. 6, depicting a portion of the adhesive layer, adhesive liner, and bead layer removed;

FIG. 8 is a partial cross-sectional view of the transfer film of FIG. 7, depicting the film rotated 180 degrees;

FIG. 9 is a partial cross-sectional view of the transfer film of FIG. 8, depicting the film following removal of the removable adhesive liner and after heat transfer to a substrate;

FIG. 10 is a partial cross-sectional view of the transfer film of FIG. 9, depicting the film after heat transfer to a substrate and removal of the temporary bead carrier;

FIG. 11 is a graph depicting the temporary bead carrier stripping force before lamination of films exposed to different levels of electron beam radiation;

FIG. 12 is a graph depicting the temporary bead carrier stripping force before lamination of films exposed to electron beams at different stages of manufacture of the films; and

FIG. 13 is a graph depicting the force to remove a laminated temporary bead carrier that has been exposed to electron beam radiation, for a variety of electron beam radiation levels and for a variety of lamination temperatures.

It should be understood that the specifics shown by way of example in the drawings and described herein in detail are not intended to limit the invention to the particular embodiments described. Rather, all modifications, equivalents, and alternatives falling within the scope of the appended claims are intended to be encompassed.

### DETAILED DESCRIPTION

Transfer films described herein, including transfer films that can be used with various mechanical cutters, such as plotter cutters and die cutters, are preferably configured for transferring beads or other particulates to a substrate without leaving undesirable carrier coating residue on the finished substrate. The transfer film usually contains the following materials or layers: optical beads, an adhesive layer, and a temporary bead carrier having a thermoset coating retaining the optical beads. In many implementations the transfer film also includes a reflective coating applied to the beads and a bead-bond layer that secures the beads to one another and to the adhesive.

The temporary bead carrier retains the beads after manufacture of the transfer film until they are applied to a substrate. Thus, the temporary bead carrier is considered temporary in that it is generally not present in a finished product or substrate bearing the beads in a functional manner, such as an article of clothing have a reflective pattern. Although considered “temporary”, it will be observed that the temporary bead carrier can retain the beads for extended periods of time, such as during shipping and warehousing of the carrier and beads prior to use. Thus, the beads may be temporarily retained for weeks, months, or years, but eventually portions of this temporary bead carrier are removed during or after application of the beads to a final substrate or surface.

In some embodiments the beads are impregnated into a thermoplastic carrier coating and then electron beam (E-beam) radiation converts the carrier coating from a thermoplastic to a thermoset material. As a result, the carrier coating no longer easily softens and flows when exposed to elevated temperatures during the heat transfer process. Also, this E-beamed carrier coating does not excessively transfer to the substrate when the beads are transferred at elevated temperatures necessary to soften the adhesive.

The transfer film can be used to make patterns of retroreflective beads on a substrate. A pattern can be formed in the beads by using a knife to outline the pattern in the beads and adhesive without cutting through the temporary bead carrier, a process known as kiss cutting. After kiss cutting, the areas of the beads and adhesive that are not part of the desired final transfer are removed (“weeded”) from the temporary bead carrier. This leaves a pattern of beads covered by adhesive plus a separate area of exposed carrier coating.

Transfer films described herein generally avoid delamination that may be experienced if the film is cut to form a pattern. Delamination during plotter cutting may occur when the adhesion force of the beads and any surrounding coatings (such as a reflective aluminum coating) to the carrier coating is too low. Delamination often takes place where the knife is being moved through the film. By increasing the transfer film stripping force between the beads and the temporary bead carrier, transfer films as described herein can exhibit reduced knife-dragging defects and thus be more suitable for use with a plotter cutter. As used herein, the stripping force is that force needed to separate the temporary bead carrier from the bead layer. While not wishing to be bound by theory, it is believed that this improvement occurs, at least in part, by oxidizing the surface of the carrier coating through electron beam irradiation, thus increasing the adhesion of the beads or their reflective coating to the carrier coating, but without having the adhesion be so strong that the temporary bead carrier cannot be removed.

The configuration and manufacture of new and useful transfer films will now be described in greater detail, along with specific aspects of various components of the films.

A. General Configuration

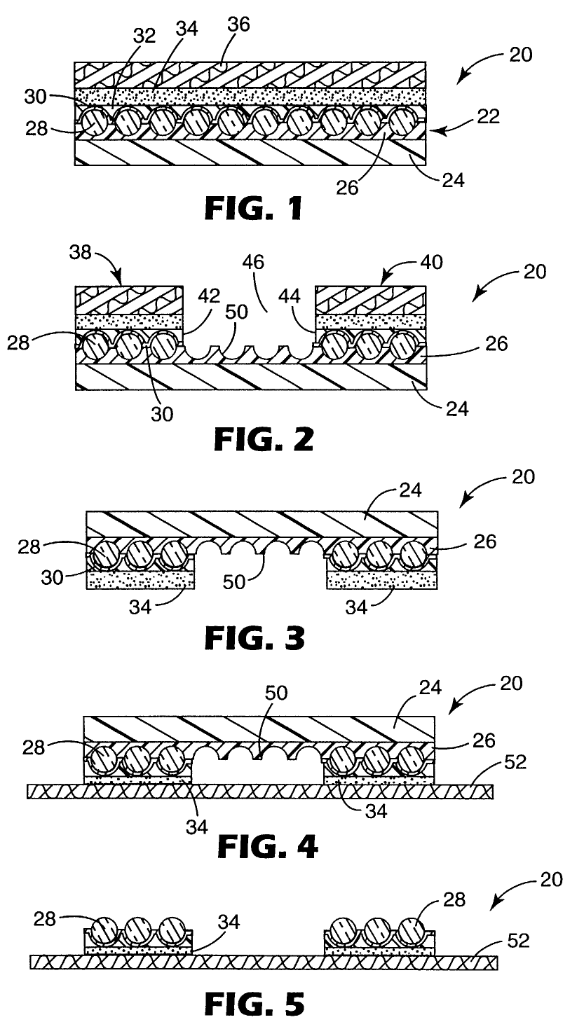

A particulate transfer film is shown in partial cross section in FIG. 1. Particulate transfer film 20 includes a temporary bead carrier 22 having a carrier backing 24 and carrier coating 26. Particulate transfer film 20 also contains a layer of particulates such as beads 28, a reflector coating 30 on the beads 28, and a bead-bond layer 32. Bead-bond layer 32 bonds the beads together, and also provides a surface to adhere an adhesive layer 34. Generally a temporary release liner 36 is positioned over the adhesive layer 34.

The particulate transfer film 20 of FIG. 1 shows a film as it may typically be delivered to a customer. The customer can subsequently form a bead pattern by removing portions of the beads 28, their reflector coating 30, bead-bond layer 32, adhesive layer 34, and release liner 36. The film 20 with portions of such layers removed is shown in FIG. 2. Only portions 38, 40 remain entirely intact. The removed material is commonly referred to as weed and leaves a partial void area 46. As shown in FIG. 2, the material known as “weed” is that which has been removed to create area 46. It will be noted that typically most or all of the carrier coating 26 and carrier backing 24 are not removed, although they can be removed in some implementations. A benefit of leaving the carrier coating 26 and carrier backing 24 of the temporary bead carrier 22 in place is that they keep the remaining portions 38, 40 of the film 20 in place and properly oriented with respect to one another. If the carrier coating 26 and carrier backing 24 were to be completely removed during cutting of the liner, bead, and bead-bond layers, then the film may lose its integrity and be difficult to properly position.

For the sake of illustration, edges 42, 44 between the “weeded” area 46 and non-weeded areas 38, 40 are shown. It is advantageous for the bond between the carrier coating 26 and the bead layer 28 to be strong enough at such edges to prevent movement and distortion of the bead layer 28 during cutting and weeding.

FIG. 2 also shows an exposed portion 50 of temporary carrier coating 26. This exposed portion 50 is likely to come in contact with the substrate during application, and thus this portion of the carrier coating 26 benefits greatly from being thermoset, thereby avoiding unintentional adhesion and/or transfer to the substrate.

FIGS. 3, 4, and 5 show the film rotated 180 degrees compared to that in FIGS. 1 and 2. This orientation is depicted to show processing steps after removal of the weeded areas and the release liner 36. FIG. 3 shows the transfer film 20 after the optional release liner 36 has been removed. FIG. 3 also shows exposed adhesive 34 and carrier coating 26 along with carrier backing 24.

FIGS. 4 and 5 show how transfer of the beads to the substrate 52 is subsequently accomplished by laying the transfer film 20 on the substrate 52 so that the carrier backing 24 is up. Heat is applied to the carrier backing 24 to activate the adhesive 34 and adhere the remaining beads 28 of the bead layer to the substrate 52. The carrier coating 26 is thermoset and does not substantially soften and adhere to the substrate 52 in the exposed areas 50 during this process. This thermoset characteristic of the carrier coating 26 reduces or eliminates the creation of residue from the carrier coating 26 left on the substrate 52.

Although the bead layer 28 adheres well to the carrier coating 26, the carrier coating 26 can be readily separated once the adhesive 34 is bonded to the substrate 52 because the beads 28 bond much more readily to the bead bond layer 32 than to the carrier coating 26. FIG. 5 shows what remains of the transfer film 20 laminated to the substrate 52 after the temporary bead carrier 22 has been removed, typically by pulling off the temporary bead carrier 22 after the transfer film and substrate have partially cooled.

FIGS. 6-10 show another particulate transfer film 60, but without the bead-bond layers or the reflective coatings of the embodiment of FIGS. 1-5. FIG. 6 shows the transfer film 60 having a temporary bead carrier 62 that contains two components: an E-beamed carrier coating 66 on a carrier backing 64. Beads 68 are impregnated into the carrier coating 66 (before E-beaming) and adhesive 74 is placed over beads 68 along with an optional release liner 76.

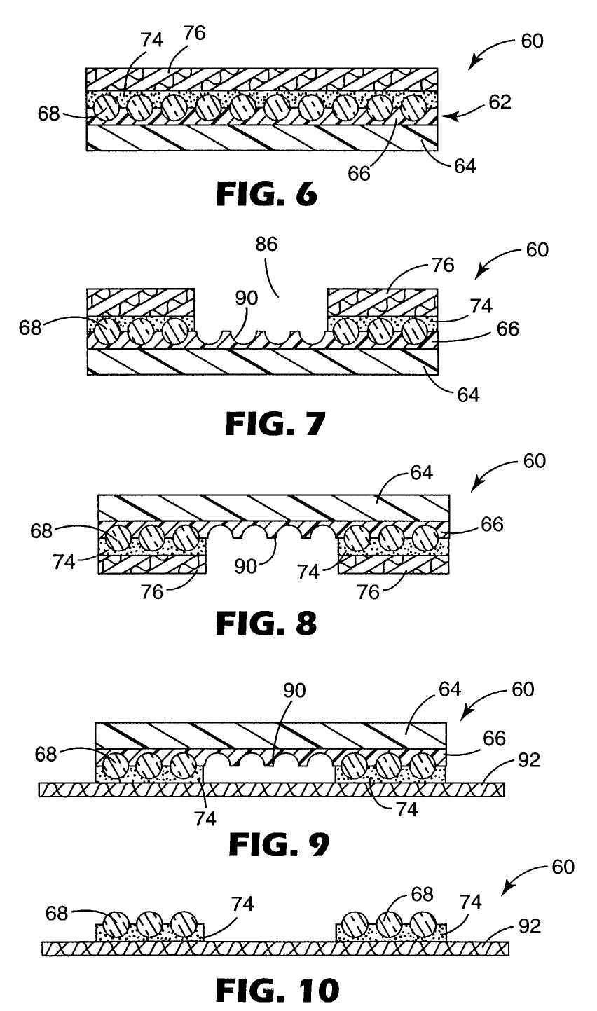

In FIG. 7 portions of the film 60 have been removed to form a removed area 86 containing an exposed surface 90 of the carrier coating 66. As noted above, the carrier coating is thermoset and therefore this exposed surface 90 does not substantially transfer to the substrate during transfer of the optical beads. FIGS. 8 and 9 show the film 60 rotated and positioned over a substrate 92 to which it is bonded. FIG. 10 depicts the substrate 92 containing the beads 68 held in place by adhesive 74 after removal of the temporary bead carrier 62 (specifically, removal of carrier coating 66 and carrier backing 64).

Besides the layers identified herein, various additional layers can optionally be added within the scope of the present disclosure.

B. Temporary Bead Carrier

The temporary bead carrier is usually made of two layers: a carrier backing that is any suitable material, such as paper or polyester; and a carrier coating that is initially thermoplastic but is subsequently modified to be made thermoset after it has been impregnated with optical beads or other particulates. Thus the carrier coating is typically a thermoset material, or consists essentially of a thermoset material or predominantly of a thermoset material in various implementations. Clear polyester film is a desirable backing, and is suitable for three reasons. First, it is more resistant to tearing than paper, which is important after heat transfer when the temporary bead carrier is removed. The tear resistant nature of polyester allows for one uniform and quick motion when the temporary bead carrier is removed and enables a wider processing window for heat transfer conditions including time, temperature and pressure. Second, the translucent nature of the polyester carrier allows for more precise positioning of the film over a substrate and easily viewing the alignment of the transfer film on the substrate. Third, polyester film has a softening point substantially above that of the carrier coating, thus insuring that the temporary bead carrier retains its integrity at temperatures needed to soften the carrier coating.

The carrier coating material can be any suitable thermoplastic polymer which can be crosslinked to form a thermoset, and can be coated at any suitable thickness. Polymers that are known to crosslink upon irradiation include polyethylene and other polyolefins, polyacrylates and their derivatives, and polystyrene. In some implementations, the carrier coating is polyethylene coated at a thickness of about 1 mil (25 μm). Generally the carrier coating material should initially soften upon heating, but is subsequently modified such that it shows significantly less softening upon heating, such as being transformed to be thermoset. Also, adequate adhesion of the carrier coating to the carrier backing should be achieved. If this is not done, these two layers may separate when the temporary bead carrier is removed, leaving the carrier coating on the surface of the transfer film.

C. Adhesive Layer

The adhesive layer can generally be any thermoplastic composition that is compatible with the substrate to which the retroreflective transfer film will be applied, and also is compatible with the bead bond or bead/reflector coating if used. Suitable adhesive layers include polyester type thermoplastic polyurethane resin. The adhesive can be applied in various ways, including various coating or lamination methods. For example, one application method is to dissolve the resin in cyclohexanone and methyl ethyl ketone. Coating is then done using roll coating to obtain a coating thickness having a dry weight of about 30 grams per square meter or about 25 microns in thickness. Another way of applying the adhesive layer is to heat laminate a dry film version of the polyester type thermoplastic polyurethane resin to the bead-bond layer. Typically the adhesive has a melting temperature below 205 degrees Celsius, more typically from about 90 to 205 degrees Celsius. The carrier melts at a temperature greater than this adhesive temperature, normally greater than 210 degrees Celsius.

D. Beads

Various types of beads may be used with the present invention, and include optical and non-optical glass beads and other small particulate material, whether spherical, aspherical, or nonspherical. Their average size will typically be greater than 40 microns and less than 120 microns, but sizes outside this range can also be used. Glass beads used in retroreflective transfer films commonly have an index of refraction of about 1.9 and a median size of 60 microns in diameter. Other materials, sizes, and refractive indices can also be used depending on the intended application. These variables usually do not greatly affect thermal transfer.

E. Additional Layers

In many implementations the transfer film also includes additional layers and materials, such as a reflective coating applied to the beads, and a bead-bond layer that secures the beads and reflective coating to one another and to the adhesive. The reflective coatings that are applied to the beads can significantly improve their reflectivity. Suitable reflective coatings include metal coatings, such as sputtered aluminum or other metals. Flake (pearlescent) reflector layers or clear mirrors (dielectric stacks) can also be incorporated. The bead-bond layer and reflective coating secure the beads to one another and also provide a substrate for the adhesive. The bead-bond layer should be selected such that it will securely hold the beads (including metal coated beads), and also such that it will bond to the adhesive and will not degrade under elevated temperatures. The bead-bond layer can be, for example, phenolic resins and nitrile butadiene rubber.

Various other materials and methods known in the art may be used with the present invention, including those taught by U.S. Pat. No. 3,172,942 (Berg), incorporated herein by reference in its entirety.

F. Methods of Making the Particulate Transfer Film

Also disclosed herein are methods of making a particulate transfer film. A variety of methods can be used, particularly methods that bind the beads to a thermoplastic carrier coating and then convert the carrier coating to a thermoset or substantially thermoset material. The thermoset carrier coating facilitates application of the beads to a substrate at elevated temperatures without transfer of the carrier coating to the substrate.

In one implementation a carrier backing material (such as polyester or paper) is coated with a thermoplastic layer, such as a layer of polyethylene, to form a temporary bead carrier. Conventional coating methods can be used to form this temporary bead carrier having a backing material and thermoplastic coating layer. Transparent glass beads are then coated onto the temporary bead carrier and are embedded into the carrier coating. One goal of this coating and impregnation process is to obtain a tightly packed, monolayer of beads.

The process of coating the beads can be accomplished through heating the temporary bead carrier by running it over a hot can with the carrier backing in contact with the hot can. The hot can is heated to a temperature sufficient to cause the thermoplastic carrier coating to become tacky. In some implementations the temperature of the temporary bead carrier is elevated to 75° C. Transparent glass beads are then applied to the tacky carrier coating. The tackiness of the carrier coating on the carrier base causes a monolayer of the glass beads to be picked up by the carrier film. Then the temporary bead carrier with the monolayer of glass beads is heated. The temporary bead carrier and glass beads are normally heated to a temperature that will soften the carrier coating and allow the beads to sink into it. Time and temperature are variables that can be used to control how far the beads will sink into the carrier coating. The longer the beads are maintained on the carrier film at an elevated temperature the deeper they will generally sink into the carrier coating. Similarly, elevated temperatures that cause increased softening of the carrier coating can result in beads sinking deeper into the carrier coating.

Half brightness angle of the finished product can be controlled by the amount that the beads sink into the carrier coating. More sinking will cause the half brightness angle to increase and less sinking will cause it to decrease. Care should be taken to not over sink the beads, which may lead to difficult removal of the temporary bead carrier. After the correct level of sink is achieved (about half of the bead diameter), the temporary bead carrier with its glass beads is allowed to cool to room temperature in order to solidify the carrier coating and prevent further movement of the beads.

A hemisphere reflector coating is then optionally applied to the bead side of the temporary bead carrier. This can be accomplished with any suitable material that will reflect light, such as silver, aluminum or pearlescent pigments. For example, aluminum can be applied through vapor deposition. The aluminum covers the exposed surface of the beads as well as the carrier coating in the areas between the beads.

Next, the film (often a web) is exposed to radiation to crosslink the thermoplastic carrier coating and convert it into a thermoset material. Electron beam radiation, which uses high energy electrons, is one way of performing this step. Electron beaming can increase the adhesion of the beads to the temporary bead carrier so that kiss cutting is accomplished without the beads and adhesive peeling up from the temporary bead carrier and causing a defect by folding over onto itself or tearing. Other methods of crosslinking include high energy radiation, such as gamma or x-rays, peroxide crosslinking, or silane crosslinking.

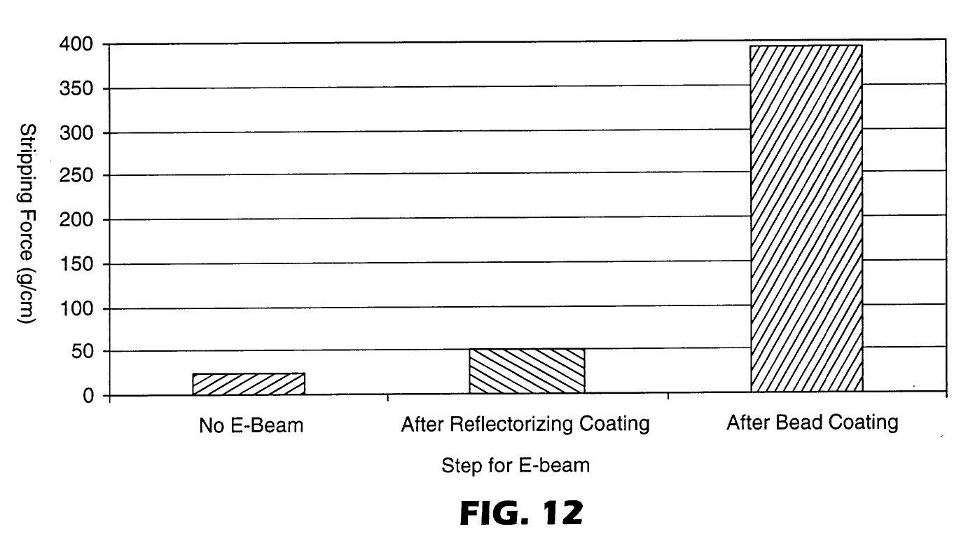

In some implementations the crosslinking step is done after the reflector coating has been applied. If E-beaming is done before the beads are applied, the carrier coating will not pick up and sink the beads since it would then be thermoset instead of thermoplastic. If it is done after the beads have been applied to the temporary bead carrier but before the reflector coating has been applied, the stripping force required to remove the temporary bead carrier after heat lamination of the finished product dramatically increases, as FIG. 12 illustrates. A significant amount of E-beaming is preferably not conducted after applying the bead-bond layer or adhesive layer because the E-beam process can degrade these layers and will not necessarily penetrate through to the carrier coating to have the desired effect.

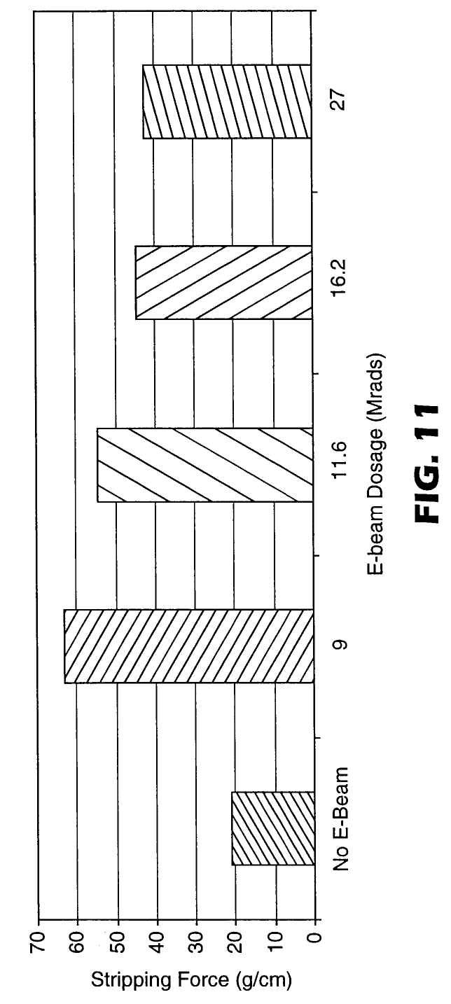

The amount or level of E-beam radiation, referred to as dosage and measured in rads or megarads (Mrad), is controlled by the variables of exposure time, voltage, and current. FIG. 11 shows that E-beam treatment results in increased stripping force needed to separate the temporary bead carrier from the transfer film, as compared to no E-beam treatment. As the dosage is further increased, the force to remove the temporary carrier from the transfer film decreases.

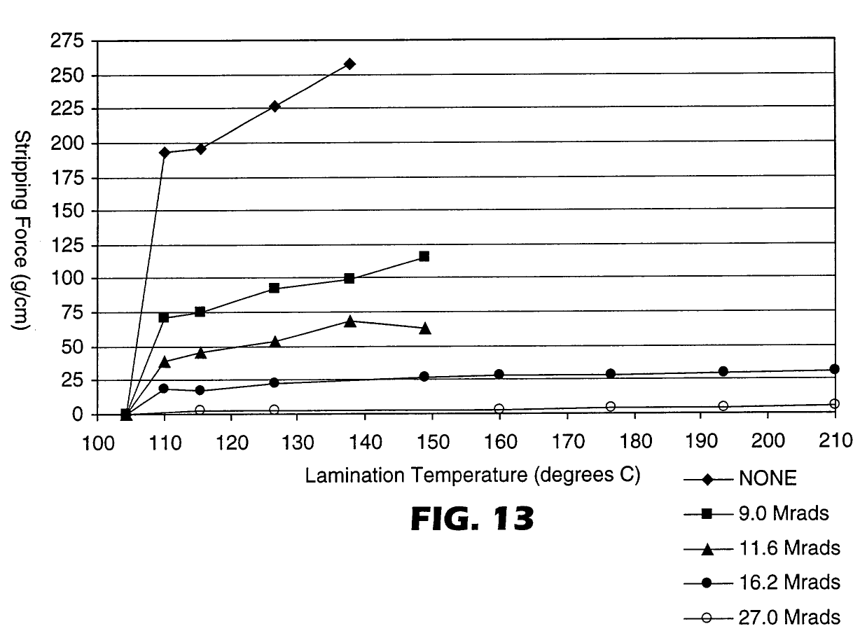

FIG. 13 shows the relationship between dosage and the stripping force required to remove the temporary bead carrier from a fabric substrate. This is the situation encountered when the kiss cut and weeded transfer film with the temporary bead carrier intact is heat laminated to a substrate. The exposed area of the temporary bead carrier can then bond to the substrate during the heat lamination step. Typically, the softening point of the carrier coating (if it has not been crosslinked) is lower than the activation temperature of the adhesive layer. However, once the layer is thermoset it will not significantly soften and thus will not adhere to the substrate or leave a residue on the substrate in the exposed area of the kiss cut and weeded transfer film.

The bead-bond layer is then optionally applied. The function of the bead-bond layer is to hold the coated beads (or other particulates) firmly in place during use. Adequate adhesion should normally be obtained to withstand washing, dry cleaning, abrasion, etc. The bead-bond layer can be composed of a mixture comprising nitrile butadiene rubber, phenolic resin, stearic acid and plasticizer, or other materials. To allow these components to be coated, a solution can be made using solvents, such as methyl isobutyl ketone and toluene.

Next, an adhesive layer can be applied over the bead-bond layer using various conventional methods. The adhesive can generally be any thermoplastic that is compatible with the substrate to which the retroreflective transfer film will be applied. Suitable adhesive layers include polyester type thermoplastic polyurethane resin.

A temporary adhesive release liner can also be added. Generally the level of adhesion between the release liner and the adhesive layer should be less than the level of adhesion between the temporary bead carrier coating and the bead surface of the retroreflective transfer film. Otherwise, an attempt to remove the release liner may separate the layer of beads from the temporary bead carrier. In order to limit the adhesion of the release liner to the adhesive, the liner should be a low surface energy material, such as polyethylene.

### G. EXAMPLES

Further embodiments are illustrated by the following examples. The particular materials and amounts recited in these examples, as well as other conditions and details, should not be construed as limiting, but are provided for illustrative purposes. All parts are by weight unless otherwise stated.

Testing was done to measure two relevant characteristics in the plotter cut application of transfer films: (1) the stripping force required to remove the temporary bead carrier from the remainder of the transfer film prior to lamination; and (2) the stripping force required to remove the temporary bead carrier from the substrate material after direct lamination thereto. The first characteristic is important to efficient removal of the weeded material after plotter cutting. If the stripping force is too high at this point in the application process, the weeding becomes very slow and inefficient due to the difficulty in removing the waste material. If the stripping force is too low at this point in the application process, premature delamination of the beads from the temporary bead carrier can occur during plotter cutting. The second characteristic, that of removing the temporary bead carrier laminated to the substrate, is important to reduce or eliminate transfer of the carrier coating to the substrate. Such a transfer results in a residue in the area surrounding the transferred graphic or indicia, which is cosmetically unacceptable. Further, such a transfer may cause difficult removal of the temporary bead carrier from the substrate.

The materials were tested with an Instron 5565 force measurement system equipped with a 2,000 gram load cell, available from Instron Corporation (Canton, Mass.); a roller bearing peel back frictionless jig; and a 2.5 cm wide roll of double sided tape. Other double sided tapes that will adequately adhere to aluminum and the test specimen are also acceptable. In addition, an aluminum panel and a HIX lamination press model N-800 available from HIX Corporation (Pittsburgh, Kans.) were used.

The following test procedure was followed to measure the first characteristic, stripping force required to remove the temporary bead carrier from the remainder of the transfer film prior to lamination of the transfer film to the substrate: The stripping force was measured at least 12 hours after the sheeting was made because the stripping force can change significantly in the initial hours following manufacture, but then stabilizes. The Instron system was calibrated using the 2,000 gram load cell. The release liner was removed from the film, and a 2.5 cm×18 cm sample was cut from the sheet. The aluminum panel was prepared by applying a 2.5 cm wide strip of double sided tape, in the long direction, down the center of a 5 cm×23 cm aluminum panel. The tape was rolled with the rubber roll using firm pressure. The liner was removed from the double sided tape, and a 2.5 cm×18 cm sample of the film was placed on the double sided tape so that the temporary bead carrier was facing up. The sample was applied such that it completely covered the double sided tape from side to side. The sample was also rolled using a rubber roller under firm pressure. Approximately 5 cm of the temporary bead carrier was stripped from the sample, making sure that the sample separated between the temporary bead carrier and the remainder of the transfer film. The aluminum panel/sample was then placed in the roller bearing peel back frictionless jig so that the sample was up. The partially stripped temporary bead carrier was placed in the upper jaw of the Instron. Using a crosshead speed of 30 cm per minute, the temporary bead carrier was peeled off the entire sample. The three highest peaks of the trace were determined, ignoring the first and last 0.6 cm of the test. The average of the three peaks was calculated and this average value recorded. For the data shown in FIG. 11, each data point is the average of three samples tested, and for the data shown in FIG. 12, each data point is the average of two samples tested.

The second characteristic, the stripping force required to remove the temporary bead carrier laminated to a substrate material, was also measured. This stripping force was measured immediately or otherwise soon after lamination to a substrate. The Instron 5565 system was calibrated using the 2,000 gram load cell. The release liner was removed from the particulate transfer film and samples were cut into 2.5 cm×18 cm pieces. The temporary bead carrier was then removed from the remainder of the transfer film and isolated. The 2.5 cm×18 cm sample of temporary bead carrier was laminated to Excellarate fabric, which was chosen as a sample fabric substrate, using a HIX press, the carrier coating side facing the substrate. The Excellerate fabric was a 65% polyester and 35% cotton blend with a weight of 105 g/m², white color, with a warp count of about 115 and fill count of about 76. This material can be purchased from Springs Industries (Rock Hill, S.C.). Conditions used for lamination were a line pressure of 2.1 kg/cm², time of 20 seconds and the temperature was varied for separate samples in a range of 104° C. to 210° C. The fabric from around the laminated 2.5 cm×18 cm temporary bead carrier was trimmed using a scissors or other appropriate cutting device. An aluminum panel was prepared by applying a 2.5 cm wide strip of double sided tape, in the long direction, down the center of a 5 cm×23 cm aluminum panel. The tape was rolled down with a rubber roll using firm pressure.

The release liner was removed from the double sided tape, and the 2.5 cm×18 cm sample was applied to the double sided tape so that the temporary bead carrier side was up. The sample was applied such that it completely covered the double sided tape from side to side. The sample was rolled using a rubber roll under firm pressure. Approximately 5 cm of the temporary bead carrier was stripped from the sample, making sure that the sample separated between the temporary bead carrier and fabric. The aluminum panel/sample was placed in the roller bearing peel back frictionless jig so that the sample is up. Using a crosshead speed of 30 cm per minute, the temporary bead carrier was peeled off the entire sample. The three highest peaks of the trace were determined, ignoring the first and last 0.6 cm of the test. The average of the three peaks was calculated and this average value recorded. Each data point in FIG. 13 is the average of three samples tested. At higher stripping forces, it may be necessary to change the double sided tape to any other suitable double sided tape which is more aggressive and will hold the fabric in place while the temporary bead carrier is stripped.

### Example 1

This example was intended to determine the approximate E-beam dosage needed to provide advantageous properties.

The temporary bead carrier was composed of polyethylene terephthalate (PET) film (95 μm) coated with polyethylene (25 μm). Beads having an average diameter of 60 μm and a refractive index of 1.9 were applied to the temporary bead carrier, and an aluminum layer that was approximately 90 nm thick was subsequently applied. The film was then E-beamed, with the beam first passing through the beads rather than through the PET. A bead bond material (comprising nitrile butadiene rubber, phenolic resin, stearic acid, and plasticizer) was coated onto the aluminized beads and temporary carrier at a weight of about 34 grams/sq. meter. The bead-bond coated film was allowed to dry and cure, beginning at about 60° C. and ramping to about 166° C. over 6 minutes.

The adhesive was a polyester type thermoplastic polyurethane resin and was coated at a weight of about 31 grams per square meter and dried, beginning at about 71° C. and ramping to about 118° C. over 6.5 minutes. The adhesive was applied by dissolving the resin in cyclohexanone and methyl ethyl ketone. Coating was then done using a roll coater to obtain a coating thickness having a dry weight of about 31 grams per square meter or about 25 microns in thickness.

The E-beam dosage was measured using a dosimeter at a line speed of 27 m/min. Dosages at other line speeds were calculated from that value. E-beam conditions were 175 kV, 140 mA, and the line speed was varied to change the amount of time the film was exposed to the radiation and thus the dosage. FIG. 11 shows how the stripping force needed to separate the beads from the temporary bead carrier changes with dosage level of E-beam. As line speed was decreased, the dosage was increased. Acceptable results were obtained at 16.2 Mrad, but the results at 27 Mrad were superior. At 27 Mrad, the line speed was about 9.1 m/min. At a line speed of 6.1 m/min., corresponding to a dosage of about 40 Mrad, the dosage applied caused the PET carrier backing to break. These results appear to indicate that the upper limit of E-beaming dosage is linked to the tensile strength of the carrier backing and how that changes with exposure to the radiation. The conclusion, based on the results, is that the preferred dosage is about 27 megarads under the conditions of this illustrative example. A further observation is that no problems with plotter cutting were experienced when using E-beamed samples as compared to samples that weren't E-beamed, thus confirming that higher stripping forces are beneficial during the kiss cutting process.

### Example 2

This example was intended to determine whether E-beaming should be done before or after application of the aluminum vapor coat onto the beads. FIG. 12 shows the difference between E-beaming after the reflectorizing coating has been applied to the beads versus after the glass beads have been coated on the temporary bead carrier but prior to the reflectorizing coating. The same methods and materials were used as in Example 1. E-beaming for this example was done at a dosage of 18 megarads (12 m/min., 175 kV and 108 mA). The results of this test indicate that under the test conditions it is beneficial to perform the E-beaming after the aluminum vapor coat has been applied to the beads.

Stripping forces of less than 118 g/cm are often acceptable by customers, while stripping forces greater than 118 g/cm start to generate problems and greater than 197 g/cm are often unacceptable. As compared to samples which haven't been E-beamed, the slight increase in stripping force when doing the E-beam step after the reflectorizing coating is one of the benefits of this invention. It helps improve the kiss cutability of the transfer film to avoid lifting, folding and tearing. The extremely high levels of stripping force noted when the radiation step is performed after the bead coating operation but before the vapor coating operation indicates it is less desirable to perform E-beaming at this step.

### Example 3

This example demonstrates, as shown in FIG. 13, the impact of E-beaming on the adhesion level of exposed carrier coating lamination to the substrate. The same methods and materials were used as in Example 1. Samples were laminated to a 65% polyester, 35% cotton fabric using a heat press. The heat press was set at a pressure of 2.1 kg/cm² and lamination time of 20 seconds. The temperature was then varied. As is shown, higher dosage levels of E-beam radiation reduce the force needed to remove the laminated exposed temporary bead carrier from the substrate. The stripping force is 1 to 2 orders of magnitude less for material that is E-beamed versus material that is not E-beamed. This stripping force is also quite consistent over a wide range of suitable lamination temperatures, which is a benefit obtained by the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

We claim:

1. A temporary particulate carrier film, the carrier film comprising:
a temporary carrier backing;
a temporary carrier composition disposed on the temporary carrier backing; and
particulates partially embedded into the temporary carrier composition;
wherein the temporary carrier composition comprises a thermoset composition.

2. The temporary particulate carrier film of claim 1, wherein the temporary carrier composition comprises a crosslinked material.

3. A temporary particulate carrier film, the carrier film comprising:
a temporary carrier backing;
a temporary carrier composition disposed on the temporary carrier backing; and
particulates partially embedded into the temporary carrier composition;
wherein the temporary carrier composition comprises a crosslinked thermoplastic polymer.

4. The temporary particulate carrier film of claim 3, wherein the temporary carrier composition comprises a thermoset composition.

5. The temporary particulate carrier film of claim 1 or 3, wherein the temporary carrier composition is formed by exposing a thermoplastic composition to an electron beam source.

6. The temporary particulate carrier film of claim 1 or 3, wherein the temporary carrier composition comprises a crosslinked polyolefin.

7. The temporary particulate carrier film of claim 1 or 3, wherein the temporary carrier composition comprises crosslinked polyethylene.

8. The temporary particulate carrier film of claim 1 or 3, wherein the particulates comprise retroreflective optical beads.

9. The temporary particulate carrier film of claim 1 or 3, further comprising a thermoplastic adhesive layer configured to permanently adhere the particulates to a substrate,
wherein the adhesive layer is positioned such that the particulates are intermediate the temporary carrier composition and the adhesive.

10. The temporary particulate carrier film of claim 1 or 3, further comprising a metallic layer, the metallic layer positioned intermediate the adhesive layer and the particulates.

11. The temporary particulate carrier film of claim 1 or 3, wherein the particulates comprise optical beads.

12. A particulate transfer film configured for transferring beads to a substrate, the transfer film comprising:
optical beads;
an adhesive layer configured to permanently adhere the optical beads to the substrate, the adhesive layer having a softening temperature of between 90 and 205° C.; and
a temporary carrier layer retaining the beads, the temporary carrier layer comprising a crosslinked polyolefin having a softening temperature greater than 210° C.;
wherein the temporary carrier layer is configured to release the beads upon permanently adhering the beads to the substrate.

13. The particulate transfer film of claim 12, wherein the adhesive layer comprises a hot melt adhesive.

14. The particulate transfer film of claim 12, wherein the crosslinked polyolefin comprises crosslinked polyethylene.

15. The particulate transfer film of claim 12, further comprising a polymeric bead bond layer positioned intermediate the adhesive layer and the temporary carrier layer, the bead bond layer configured and arranged to permanently secure the optical beads.

16. The particulate transfer film of claim 15 wherein the bead bond layer is selected from the group consisting of a phenolic resin, nitrile butadiene rubber, or a combination thereof.

17. The particulate transfer film of claim 16 further comprising a metallic coating on the optical beads, the metallic coating positioned intermediate the optical beads and the bead bond layer.

18. A method of making a particulate transfer film, the method comprising:
providing a backing film;
applying a thermoplastic composition to the backing film;
impregnating the thermoplastic layer with a particulate material; and
crosslinking the thermoplastic composition to form a thermoset composition.

19. The method of claim 18, further comprising applying a metallic coating to the particulate material prior to crosslinking the thermoplastic composition.

20. The method of claim 19, further comprising adding a bead bond composition to the transfer film after impregnating the thermoplastic composition with the particulate material.

21. The method of claim 18, further comprising adding an adhesive to the particulate transfer film after crosslinking the thermoplastic composition.

22. The method of claim 21, wherein the adhesive comprises a thermoplastic composition.
